(19) United States
(12) Patent Application Publication
(10) Pub. No.: US 2018/0341334 A1
(43) Pub. Date: Nov. 29, 2018

(54) Computer Interface Device

(71) Applicant: Stephen Sigmon, Taylorsville, NC (US)

(72) Inventor: Stephen Sigmon, Taylorsville, NC (US)

(21) Appl. No.: 15/602,176

(22) Filed: May 23, 2017

(51) Int. Cl. G06F 3/023; G06F 3/0354

(52) U.S. Cl. CPC G06F 3/023; G06F 3/03547

(57) ABSTRACT

A computer interface device for keystroke launching of computer programs includes a housing. A microcontroller is coupled to and positioned in the housing. The microcontroller is configured to operationally couple to a computer. A keypad and a plurality of first keys are coupled to an upper face of the housing. The keypad and the first keys are operationally coupled to the microcontroller. The keypad is configured to compel the microcontroller to communicate entries, such as alphanumeric characters, to the computer. Each first key is configured to be depressed to compel the microcontroller to communicate a respective command to the computer to launch an associated program. The improvement is the plurality of first keys that is coupled to the upper face of the housing. Each first key is configured to be depressed to compel the microcontroller to communicate the respective command to the computer to launch the associated program.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to interface devices and more particularly pertains to a new interface device for keystroke launching of computer programs.

### BRIEF SUMMARY OF THE INVENTION

An embodiment of the disclosure meets the needs presented above by generally comprising a housing. A microcontroller is coupled to and positioned in the housing. The microcontroller is configured to operationally couple to a computer. A keypad and a plurality of first keys are coupled to an upper face of the housing. The keypad and the first keys are operationally coupled to the microcontroller. The keypad is configured to compel the microcontroller to communicate entries, such as alphanumeric characters, to the computer. Each first key is configured to be depressed to compel the microcontroller to communicate a respective command to the computer to launch an associated program. The improvement is the plurality of first keys that is coupled to the upper face of the housing. Each first key is configured to be depressed to compel the microcontroller to communicate the respective command to the computer to launch the associated program.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a computer interface device according to an embodiment of the disclosure.

FIG. 2 is a top view of an embodiment of the disclosure.

### DETAILED DESCRIPTION OF THE INVENTION

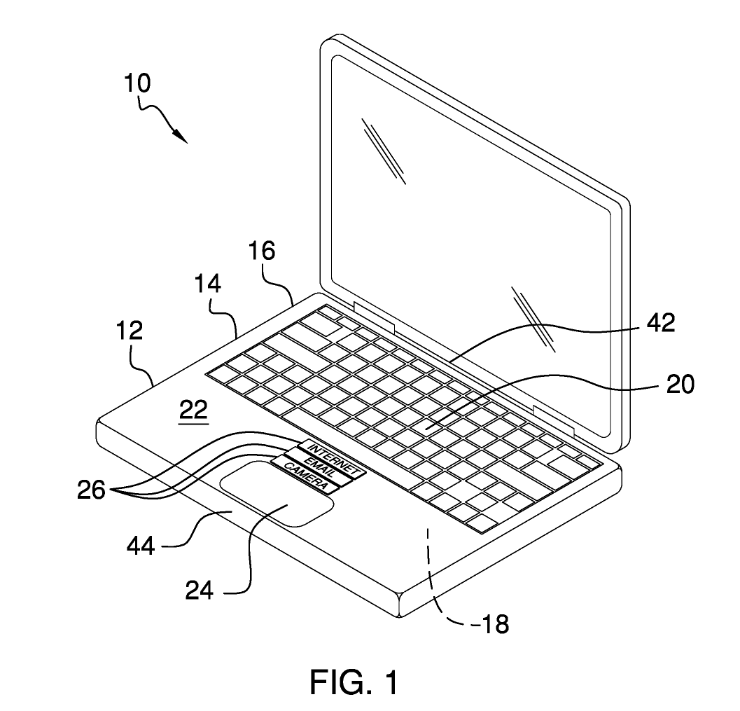

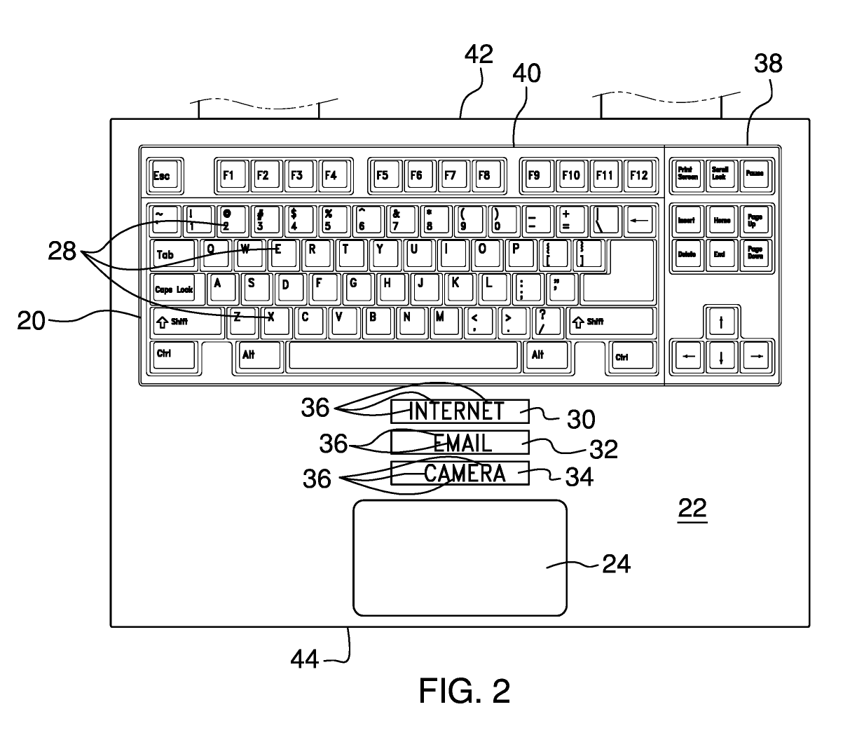

With reference now to the drawings, and in particular to FIGS. 1 and 2 thereof, a new interface device embodying the principles and concepts of an embodiment of the disclosure and generally designated by the reference numeral 10 will be described.

As best illustrated in FIGS. 1 and 2, the computer interface device 10 generally comprises a housing 12. In one embodiment, the housing 12 is substantially rectangularly box shaped. In another embodiment, the housing 12 comprises a computer housing 14 so that the housing 12 is integral to a computer 16, such as a laptop computer or netbook computer.

A microcontroller 18 is coupled to and is positioned in the housing 12. The microcontroller 18 is configured to operationally couple to a computer 16. A keypad 20 is coupled to an upper face 22 of the housing 12. The keypad 20 is operationally coupled to the microcontroller 18. The keypad 20 is configured to compel the microcontroller 18 to communicate entries, such as alphanumeric characters, to the computer 16.

A mouse pad 24 is coupled to the housing 12. The mouse pad 24 is operationally coupled to the microcontroller 18. The mouse pad 24 is configured to compel the microcontroller 18 to compel the computer 16 to control a cursor.

A plurality of first keys 26 is coupled to the upper face 22 of the housing 12. The plurality of first keys 26 is operationally coupled to the microcontroller 18. Each first key 26 is configured to be depressed to compel the microcontroller 18 to communicate a respective command to the computer 16 to launch an associated program. In one embodiment, each first key 26 is substantially dimensionally equivalent to three alphanumeric buttons 28 of the keypad 20. In another embodiment, the plurality of first keys 26 comprises a web browser button 30, an email button 32, and a camera button 34.

Indicia 36 are coupled to the plurality of first keys 26. Respective indicia 36 are positioned on an associated first key 26 so that the associated first key 26 is configured to visually present to a user the respective command to be communicated by the microcontroller 18 to the computer 16 when the associated first key 26 is depressed.

In one embodiment, a plurality of second keys 38 is coupled to the upper face 22 of the housing 12. The plurality of second keys 38 is operationally coupled to the microcontroller 18. Each second key 38 is configured to be depressed to compel the microcontroller 18 to communicate a respective control command to the computer 16 to control the cursor and a screen.

In another embodiment, a plurality of third keys 40 is coupled to the upper face 22 of the housing 12. The plurality of third keys 40 is operationally coupled to the microcontroller 18. Each third key 40 is configured to be depressed to compel the microcontroller 18 to communicate a respective function to the computer 16.

In yet another embodiment, the keypad 20 is positioned proximate to a first edge 42 of the housing 12. The mouse pad 24 is positioned proximate to a second edge 44 of the housing 12 and is substantially centrally positioned relative to the keypad 20. The plurality of first keys 26 is positioned between the keypad 20 and the mouse pad 24. The plurality of second keys 38 is positioned between the keypad 20 and a respective opposing side 46 of the housing 12. The plurality of third keys 40 is positioned between the keypad 20 and the first edge 42 of the housing 12. In still yet another embodiment, the plurality of first keys 26 is positioned vertically between the keypad 20 and the mouse pad 24.

In use, the keypad 20 is configured to compel the microcontroller 18 to communicate the entries, such as the alphanumeric characters, to the computer 16. The mouse pad 24 is configured to compel the microcontroller 18 to compel the computer 16 to control the cursor. Each first key 26 is configured to be depressed to compel the microcontroller 18 to communicate the respective command to the computer 16 to launch the associated program. The indicia 36 are positioned on the first keys 26 so that the each first key 26 is configured to visually present to the user the respective command to be communicated by the microcontroller 18 to the computer 16 when the first key 26 is depressed. Each second key 38 is configured to be depressed to compel the microcontroller 18 to communicate the respective control command to the computer 16 to control the cursor and the screen. Each third key 40 is configured to be depressed to compel the microcontroller 18 to communicate the respective function to the computer 16.

The improvements are the plurality of first keys 26 that is coupled to the housing 12 and the indicia 36 that are positioned on the first keys 26. Each first key 26 is configured to be depressed to compel the microcontroller 18 to communicate the respective command to the computer 16 to launch the associated program. The indicia 36 are positioned on the first keys 26 so that each first key 26 is configured to visually present to the user the respective command to be communicated by the microcontroller 18 to the computer 16 when the first key 26 is depressed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A computer interface device comprising:
a housing;
a microcontroller coupled to and positioned in said housing, said microcontroller being configured for operationally coupling to a computer;
a keypad coupled to an upper face of said housing, said keypad being operationally coupled to said microcontroller, said keypad being configured for compelling said microcontroller for communicating entries, such as alphanumeric characters, to said computer;
a plurality of first keys coupled to said upper face of said housing, said plurality of first keys being operationally coupled to said microcontroller, each said first key being configured for depressing for compelling said microcontroller for communicating a respective command to said computer for launching an associated program, each said first key being substantially dimensionally equivalent to three alphanumeric buttons of said keypad.

2. The device of claim 1, further including said housing being substantially rectangularly box shaped.

3. The device of claim 1, further including said housing comprising a computer housing such that said housing is integral to said computer, such as a laptop computer or netbook computer.

4. (canceled)

5. The device of claim 1, further including said plurality of first keys comprising a web browser button, an email button, and a camera button.

6. The device of claim 1, further including indicia coupled to said plurality of first keys, wherein respective said indicia are positioned on an associated said first key such that said associated said first key is configured for visually presenting to a user the respective command to be communicated by said microcontroller to said computer upon depressing said associated said first key.

7. The device of claim 1, further including a plurality of second keys coupled to said upper face of said housing, said plurality of second keys being operationally coupled to said microcontroller, each said being second key configured for depressing for compelling said microcontroller for communicating a respective control command to said computer for cursor and screen controlling.

8. The device of claim 7, further including a plurality of third keys coupled to said upper face of said housing, said plurality of third keys being operationally coupled to said microcontroller, each said third key being configured for depressing for compelling said microcontroller for communicating a respective function to said computer.

9. The device of claim 8, further including said keypad being positioned proximate to a first edge of said housing.

10. The device of claim 9, further including a mouse pad coupled to said housing, said mouse pad being operationally coupled to said microcontroller, said mouse pad being configured for compelling said microcontroller for compelling said computer for cursor controlling.

11. The device of claim 10, further including said mouse pad being positioned proximate to a second edge of said housing substantially centrally positioned relative to said keypad.

12. The device of claim 11, further comprising:
said plurality of second keys being positioned between said keypad and a respective opposing side of said housing;
said plurality of third keys being positioned between said keypad and said first edge of said housing; and
said plurality of first keys being positioned between said keypad and said mouse pad.

13. The device of claim 12, further including said plurality of first keys being positioned vertically between said keypad and said mouse pad.

14. A computer interface device comprising:
a housing, said housing being substantially rectangularly box shaped;
a microcontroller coupled to and positioned in said housing, said microcontroller being configured for operationally coupling to a computer;
a keypad coupled to an upper face of said housing, said keypad being operationally coupled to said microcontroller, said keypad being configured for compelling said microcontroller for communicating entries, such as alphanumeric characters, to said computer, said keypad being positioned proximate to a first edge of said housing;
a mouse pad coupled to said housing, said mouse pad being operationally coupled to said microcontroller, said mouse pad being configured for compelling said microcontroller for compelling said computer for cursor controlling, said mouse pad being positioned proximate to a second edge of said housing substantially centrally positioned relative to said keypad;
a plurality of first keys coupled to said upper face of said housing, said plurality of first keys being operationally coupled to said microcontroller, each said first key being configured for depressing for compelling said microcontroller for communicating a respective command to said computer for launching an associated program, each said first key being substantially dimensionally equivalent to three alphanumeric buttons of said keypad, said plurality of first keys comprising a web browser button, an email button, and a camera button, said plurality of first keys being positioned between said keypad and said mouse pad, said plurality of first keys being positioned vertically between said keypad and said mouse pad;
indicia coupled to said plurality of first keys, wherein respective said indicia are positioned on an associated said first key such that said associated said first key is configured for visually presenting to a user the respective command to be communicated by said microcontroller to said computer upon depressing said associated said first key;
a plurality of second keys coupled to said upper face of said housing, said plurality of second keys being operationally coupled to said microcontroller, each said being second key configured for depressing for compelling said microcontroller for communicating a respective control command to said computer for cursor and screen controlling, said plurality of second keys being positioned between said keypad and a respective opposing side of said housing;
a plurality of third keys coupled to said upper face of said housing, said plurality of third keys being operationally coupled to said microcontroller, each said third key being configured for depressing for compelling said microcontroller for communicating a respective function to said computer, said plurality of third keys being positioned between said keypad and said first edge of said housing; and
wherein the improvement is plurality of first keys being coupled to said upper face of said housing such that each said first key is configured for depressing for compelling said microcontroller for communicating the respective command to said computer for launching the associated program.

15. The device of claim 14, further including said housing comprising a computer housing such that said housing is integral to said computer, such as a laptop computer or netbook computer.
